(19) United States
(12) Patent Application Publication
(10) Pub. No.: US 2025/0246981 A1
(43) Pub. Date: Jul. 31, 2025

(54) COIL SEPARATION METHOD AND COIL SEPARATION DEVICE

(71) Applicant: HONDA MOTOR CO., LTD., TOKYO (JP)

(72) Inventors: Noriyuki MATSUSHITA, TOKYO (JP); Junya OGURI, TOKYO (JP)

(21) Appl. No.: 19/016,822

(22) Filed: Jan. 10, 2025

(30) Foreign Application Priority Data
Jan. 29, 2024 (JP) 2024-010689

(51) Int. Cl. H02K 15/50

(52) U.S. Cl. CPC H02K 15/50

(57) ABSTRACT

A coil separation method of separating a coil from a stator including: a stator core having an inner circumferential surface in which a plurality of slots are formed; and the coil placed in the plurality of slots. The coil separation method includes: cutting, from the coil, a coil end portion of the coil protruding from end surfaces of the stator core; and separating the coil from the stator core by pushing cut ends of the coil with a pushing member in a state where teeth of the stator core that are positioned between the slots are supported by a support member.

### CROSS-REFERENCE TO RELATED APPLICATIONS

This application is based upon and claims the benefit of priority from Japanese Patent Application No. 2024-010689 filed on Jan. 29, 2024, the contents of which are incorporated herein by reference.

### BACKGROUND OF THE INVENTION

### Field of the Invention

The present disclosure relates to a coil separation method and a coil separation device.

### Description of the Related Art

In recent years, from the viewpoint of global environmental protection, attempts have been made to remove coils from stators of used rotating electric machines and recycle the coils without simply discarding the stators.

As a method of separating a coil from a stator, conventionally known is pressing coil end portions, which protrude in a central axis direction from both end surfaces of a stator core, radially inward of the stator core and taking out the coil from the shaft hole of the stator core (for example, see JP 2021-013222 A).

### SUMMARY OF THE INVENTION

In particular, coils used for stators of in-vehicle rotating electric machines have a higher coil density than coils used for stators of rotating electric machines of household electric appliances, and are bonded to each other by varnish or the like. Therefore, when such coils are forcibly deformed, the outer surfaces of the coil end portions need to be pressed with a strong force. Further, the annular coil end portions need to be pressed at a plurality of positions in the circumferential direction. Therefore, large pressing devices need to be arranged at the plurality of positions in the circumferential direction of the stator, leading to an increase in the size of the separating device. Further, since the strong force is required to separate the coils from the stators, it is also difficult to take out the coils from the stators simply by pulling the coils along the direction of the central axis, for example.

In the method of forcibly deforming the outer surfaces of the coil end portions by strongly pressing the outer surfaces, substances other than the coils are likely to adhere to the coil surfaces. In case of adhesion of other substances to the coils, when the coils having been removed from the stators are melted for recycling, the melted material tends to contain higher concentration of impurities, which may limit the range in which the coils can be recycled.

Therefore, it is desired to easily remove the coils from the stators without forcibly deforming the coils.

The present invention has the object of solving the aforementioned problem.

A first aspect of the present disclosure is a coil separation method of separating a coil from a stator including a stator core having an inner circumferential surface in which a plurality of slots are formed and the coil placed in the plurality of slots, the coil separation method including: cutting, from the coil, a coil end portion protruding from any of end surfaces of the stator core; and separating the coil from the stator core by pushing cut ends of the coil with a pushing member in a state where teeth of the stator core that are positioned between the slots are supported by a support member.

A second aspect of the present disclosure is a coil separation device configured to remove a coil from a stator including a stator core having an inner circumferential surface in which a plurality of slots are formed and the coil placed in the plurality of slots, the coil separation device including: a support member configured to support teeth of the stator core that are positioned between the slots of the stator core, from which a coil end portion protruded from any of end surfaces of the stator core has been cut; and a pushing member configured to push cut ends of the coil to separate the coil from the stator core, in a state where the teeth are supported.

According to the aspect of the present disclosure, it is not necessary to forcibly deform the outer surfaces of the coil end portions by pressing. Therefore, the amount of impurities contained in the coil separated from the stator core does not increase, and the range in which the coil can be recycled is not limited. Moreover, the coil can be smoothly moved in the slots along the central axis of the stator core. As a result, the coil can be easily removed from the stator without forcibly deforming the coil.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of a stator;

FIG. 2 is view showing a segment conductor;

FIG. 3 is a schematic view showing a coil separation device;

FIG. 4 is a perspective view showing the arrangement jig;

FIG. 5 is a view showing a state in which the stator from which both a first coil end portion and a second coil end portion have been cut is supported by a support member;

FIG. 6 is a bottom view showing the pressing jig;

FIG. 7 is a diagram showing a cutting step;

FIG. 8 is a view showing a state in which the stator is arranged with respect to the coil separation device;

FIG. 9 is a diagram showing a pressing step;

FIG. 10 is a view showing a state in which the coil is separated from the stator core; and

FIG. 11 is a view showing a state in which the pressing jig is returned to the initial position.

### DETAILED DESCRIPTION OF THE INVENTION

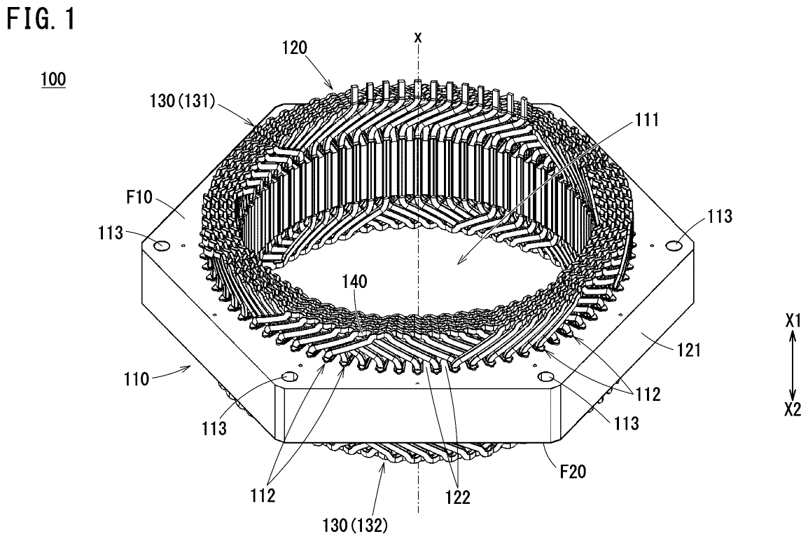

FIG. 1 is a perspective view of a stator 100. The stator 100 includes a stator core 110 and a coil 120.

Here, a description will be given concerning directions shown in the drawings. The X1-X2 direction extends along the central axis X of the stator 100 and the stator core 110. A pressing jig 3 to be described later moves linearly along the X1-X2 direction. In each of the drawings, an X1 direction points upward, and an X2 direction points downward. However, the X1-X2 direction is not necessarily limited to the upward direction and the downward direction along the direction of gravity. The X1-X2 direction may be inclined with respect to the direction of gravity, for example, may be the horizontal direction.

The stator core 110 is formed by laminating a plurality of annular thin electromagnetic steel plates having an opening at the center. The stator core 110 has a shaft hole 111, a first end surface F10, and a second end surface F20. The shaft hole 111 is positioned at the center of the stator core 110. The first end surface F10 faces in the X1 direction along the central axis X of the stator core 110. The second end surface F20 faces in the X2 direction along the central axis X of the stator core 110.

Multiple slots 112 are formed at equal intervals in the inner circumferential surface of the stator core 110. Each of the slots 112 is opened toward the shaft hole 111 in a narrow groove shape. The slots 112 are formed linearly in a direction along the central axis X of the stator core 110. The slots 112 extend throughout the stator core 110 from the first end surface F10 and the second end surface F20 to open at the first end surface F10 and the second end surface F20.

The stator core 110 is formed with a plurality of through holes 113 penetrating through the stator core 110 in a direction along the central axis X of the stator core 110. The plurality of through holes 113 are arranged at equal intervals in the circumferential direction of the stator core 110. The number of the through holes 113 is six, but is not limited thereto.

The stator core 110 includes a core body 121 with a number of teeth 122. The core body 121 forms an outer circumferential portion of the stator core 110. The teeth 122 are formed between the slots 112 of the stator core 110. The teeth 122 protrude from the core body 121 toward the central axis X of the stator core 110.

The coil 120 is an aggregate of conductors formed of a plurality of flat wires. More specifically, the coil 120 is an aggregate of a plurality of segment conductors 140. Each of the plurality of segment conductors 140 constituting the coil 120 is placed in each slot 112 of the stator core 110. The coil 120 has two coil end portions 130 protruding from the end surfaces of the stator core 110. One of the two coil end portions 130 is a first coil end portion 131 that protrudes from a first end surface F10 that is one end surface of the stator core 110. The other of the two coil end portions 130 is a second coil end portion 132 that protrudes from a second end surface F20 that is the other end surface of the stator core 110.

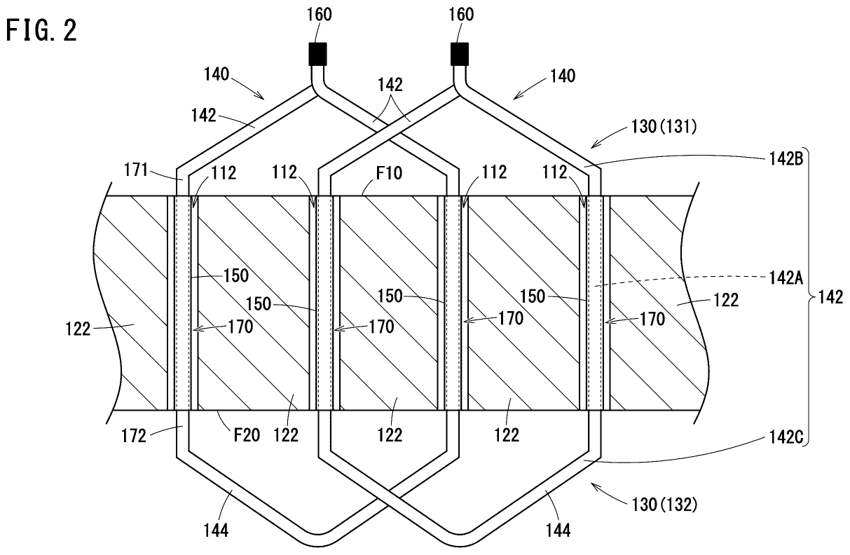

The coil 120 is formed by connecting the plurality of segment conductors 140. FIG. 2 is a diagram showing the segment conductors 140.

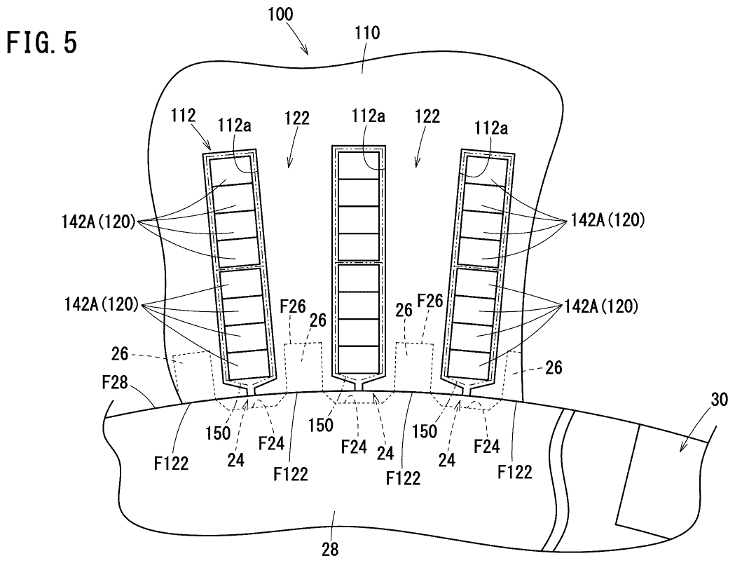

Each of the segment conductors 140 includes a pair of leg portions 142 and a turn portion 144 connecting the pair of leg portions 142. Each of the leg portions 142 of the segment conductor 140 is inserted into the slot 112. Each of the leg portions 142 has a first portion 142A placed in the slot 112, a second portion 142B protruding from the first end surface F10, and a third portion 142C protruding from the second end surface F20. Multiple leg portions 142 are inserted into one slot 112. The multiple leg portions 142 inserted into one slot 112 are the leg portions 142 of different segment conductors 140. The first portions 142A are covered with insulation papers 150. Specifically, the plurality of first portions 142A located in one slot 112 are divided into several groups by the insulation papers 150, and the first portions 142A of each group is covered by one insulation paper 150 (see FIG. 5).

The first coil end portion 131 is constituted by the second portions 142B of the leg portions 142. The second coil end portion 132 is constituted by the third portions 142C of the leg portions 142 and the turn portions 144. The first coil end portion 131 includes welded portions 160. One segment conductor 140 and another segment conductor 140 are connected at the welded portion 160. The second coil end portion 132 does not include welded portions 160.

Straight portions 170 (see FIG. 2) extending in a direction along the central axis X of the stator core 110 are formed in each of the segment conductors 140. Each of the first portion 142A, roots 171 of the first coil end portion 131, and roots 172 of the second coil end portion 132 include the straight portion 170. The length of the straight portions 170 included in the roots 171 of the first coil end portion 131 is shorter than the length of the straight portions 170 included in the roots 172 of the second coil end portion 132. This is due to the way in which the segment conductor 140 is formed.

That is, a U-shape conductor (flat wire) is inserted into the slots 112 from the side of the second end surface F20 of the stator core 110, and protrudes from the slots 112 on the side of the first end surface F10 of the stator core 110, and the protruding ends of the U-shaped conductor are bent so as to approach one another. Then, the protruding ends of each segment conductor 140 bent to approach one another is welded to form the first coil end portion 131 (the second portion 142B of the legs 142 of the segment conductor 140). When bending the protruding ends of the segment conductor 140, the protruding ends of the segment conductor 140 are more easily bent near the stator core 110 serving as a fulcrum. Therefore, the length of the straight portions 170 included in the roots 171 of the first coil end portion 131 becomes relatively short.

In the present embodiment, after cutting both the first coil end portion 131 and the second coil end portion 132 of the coil 120 included in the stator 100 as described above, the coil 120 is separated from the stator core 110.

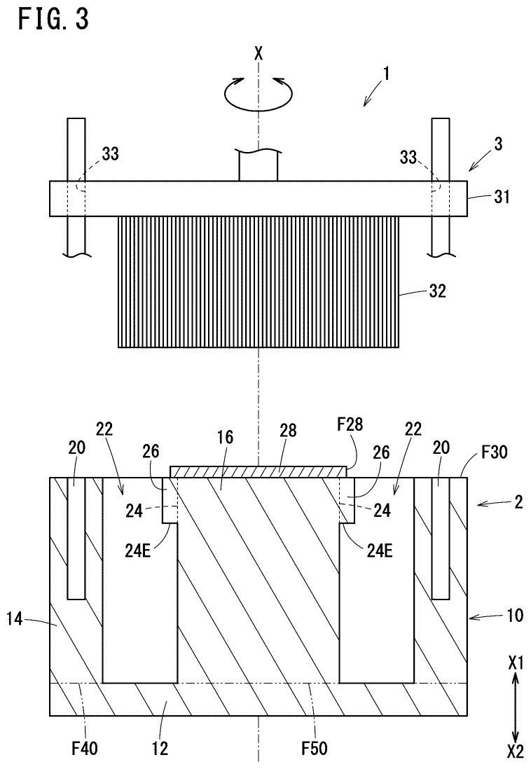

Next, the coil separation device 1 will be described with reference to FIGS. 3 to 6. The coil separation device 1 includes an arrangement jig 2 and a pressing jig 3.

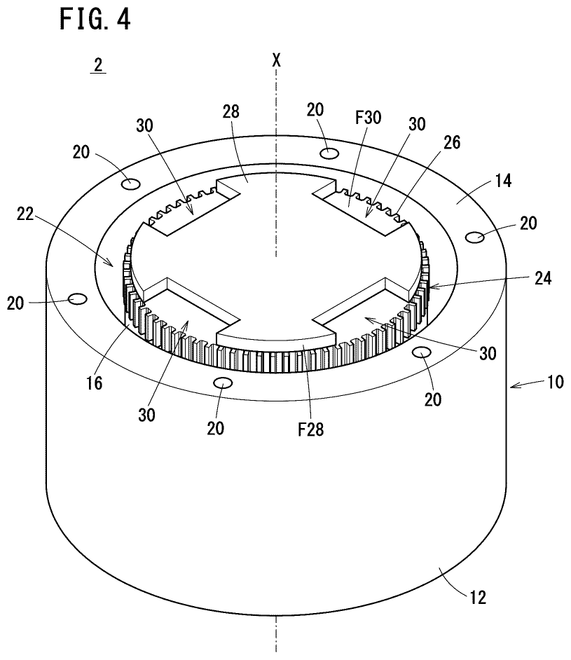

As shown in FIGS. 3 and 4, the arrangement jig 2 includes a support member 10 that supports the stator 100 from which the first coil end portion 131 and the second coil end portion 132 have been cut. The support member 10 may be fixed to a predetermined position of the coil separation device 1. Alternatively, the support member 10 may be disposed at a predetermined position of the coil separation device 1 by the operation of a moving mechanism such as a robot hand, a slide table, and the like (not shown) during the coil separation operation.

The support member 10 is formed of, for example, metal such as stainless steel. The support member 10 has a support surface F30 with which the stator core 110 is brought into contact. The support surface F30 is flat along a direction perpendicular to the axis of the support member 10.

The support member 10 has a disc-shaped base portion 12, a cylindrical tubular outer support portion 14, and a columnar inner support portion 16. The base portion 12, the outer support portion 14, and the inner support portion 16 may be formed integrally or separately. In the case where the base portion 12, the outer support portion 14, and the inner support portion 16 are formed separately, the base portion 12, the outer support portion 14, and the inner support portion 16 are joined by welding or the like.

The outer support portion 14 and the columnar inner support portion 16 are fixed to an end surface of the base portion 12. The base portion 12 is disposed at a predetermined position of the coil separation device 1. The support member 10 may not have the base portion 12. In this case, the outer support portion 14 and the columnar inner support portion 16 are disposed at predetermined positions of the coil separation device 1.

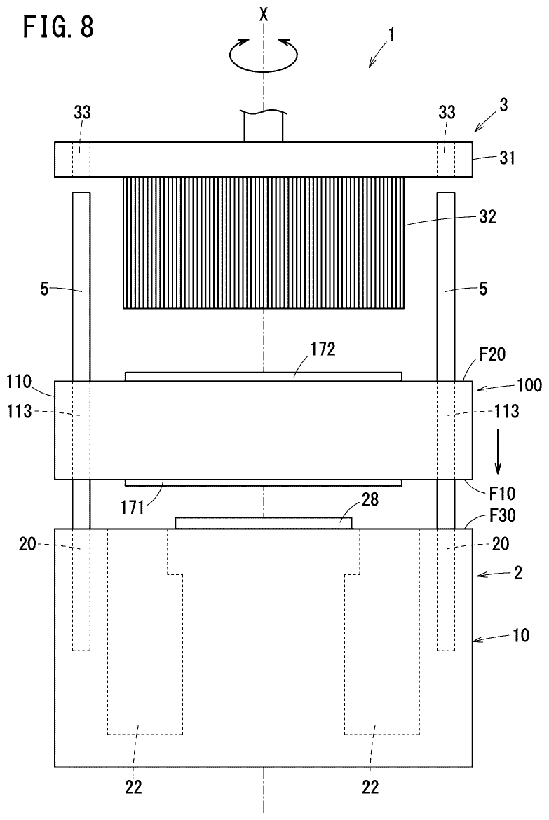

A plurality of support post insertion holes 20 are formed in the outer support portion 14. The plurality of support post insertion holes 20 are formed at positions corresponding to the positions of the plurality of through holes 113 formed in the stator core 110. The support post insertion holes 20 are used for standing rod-shaped straight guiding support posts 5 (see FIG. 8) in the process of separating the coil 120 from the stator 100. The support post insertion holes 20 extend from one end surface of the outer support portion 14 in a direction along the axis of the outer support portion 14. The one end surface of the outer support portion 14 is included in the support surface F30 of the support member 10. The axis of the outer support portion 14 coincides with the axis of the support member 10.

The core body 121 of the stator 100, from which both the first coil end portion 131 and the second coil end portion 132 have been cut, is brought into contact with the one end surface of the outer support portion 14. To be more specific, the core body 121 of the stator core 110 is brought into contact with the one end surface of the outer support portion 14 at the first end surface F10.

The inner support portion 16 is positioned on the inner side of the outer support portion 14 with a gap 22 therebetween. The coil 120 pushed out from the stator core 110 can pass through the gap 22 between the inner support portion 16 and the outer support portion 14. The gap 22 extends from the support surface F30 of the support member 10 along the axis of the support member 10 to the other end portion F40 (FIG. 3) of the outer support portion 14. The gap 22 is defined by the inner support portion 16, the outer support portion 14, and the base portion 12. Therefore, the gap 22 can accommodate the coil 120 pushed out from the stator core 110.

A plurality of recesses 24 are formed in the outer peripheral surface of the inner support portion 16 at intervals in the circumferential direction of the inner support portion 16 (see FIG. 4). Each of the plurality of recesses 24 is of the same shape. The recesses 24 extend from one end surface of the inner support portion 16 in a direction along the axis of the inner support portion 16. The one end surface of the inner support portion 16 is included in the support surface F30 of the support member 10. The axis of the inner support portion 16 coincides with the axis of the support member 10.

The position of ends (lower ends) 24E (FIG. 3) of the recesses 24 is arranged between the one end portion (support surface F30 of the support member 10) of the inner support portion 16 and the other end portion F50 (FIG. 3) of the inner support portion 16, but is not limited thereto. The ends 24E of the recesses 24 may reach the other end F50 of the inner support portion 16.

Projections 26 are defined by the recesses 24 adjacent to each other in the circumferential direction of the inner support portion 16. In other words, in a plan view along the central axis X, the inner support portion 16 is formed in a gear shape (see FIG. 4). The number of the protrusions 26 is the same as the number of the teeth 122, but is not limited thereto. The number of the protrusions 26 may be smaller than the number of the teeth 122. In this case, in order to stably support the stator 100, the protrusions 26 are preferably arranged in point symmetry with respect to the axis of the inner support portion 16.

The teeth 122 of the stator 100, from which both the first coil end portion 131 and the second coil end portion 132 have been cut, are brought into contact with the protrusions 26. FIG. 5 is a view showing a state in which the stator 100, from which both the first coil end portion 131 and the second coil end portion 132 have been cut, is supported by the support member 10.

As shown in FIG. 5, the tip end portions of the teeth 122 of the stator core 110 is brought into contact with the protrusions 26 at the first end surface F10 (see FIG. 1). The area of the portions of the protrusions 26 with which the teeth 122 are in contact is set based on the volume of the coil 120. The width of the recess 24 in the circumferential direction of the inner support portion 16 is larger than the width of the slot 112 in the circumferential direction of the stator core 110. The width of the protrusion 26 in the circumferential direction of the inner support portion 16 is smaller than the width of the tooth 122 in the circumferential direction of the stator core 110.

As shown in FIGS. 3 to 5, the support member 10 may include a positioning portion 28 for positioning the stator core 110 in the radial direction, in addition to the disc-shaped base portion 12, the cylindrical tubular outer support portion 14, and the columnar inner support portion 16.

As shown in FIGS. 3 and 4, the positioning portion 28 is provided on the one end surface of the inner support portion 16. The one end surface of the inner support portion 16 is included in the support surface F30 of the support member 10. The positioning portion 28 may be formed integrally with the inner support portion 16 or may be formed separately from the inner support portion 16. When the positioning portion 28 is formed separately from the inner support portion 16, the positioning portion 28 and the inner support portion 16 are joined by welding or the like. The positioning portion 28 is formed in a plate shape, but is not limited thereto. The positioning portion 28 protrudes from the support surface F30 of the support member 10, and has a circumferential surface F28 in a direction along the circumferential direction of the inner support portion 16. The circumferential surface F28 of the positioning portion 28 extends in a direction along the axis of the inner support portion 16.

As shown in FIG. 5, the circumferential surface F28 of the positioning portion 28 is positioned between the tip end surfaces F26 of the projections 26 and the bottom surfaces F24 of the recesses 24 in a plan view along the central axis X. In other words, the bottom surfaces F24 of the recesses 24 are positioned inwardly of the circumferential surface F28 of the positioning portion 28. In a state where the teeth 122 are supported by the protrusions 26 of the inner support portion 16, the positioning portion 28 is positioned on the inner side of the stator core 110, and the circumferential surface F28 of the positioning portion 28 faces the tip end surfaces F122 of the teeth 122. The circumferential surface F28 of the positioning portion 28 abuts on the tip end surfaces F122 of the teeth 122, but is not limited thereto. A slight gap may be formed between the circumferential surface F28 of the positioning portion 28 and the tip end surfaces F122 of the teeth 122. This gap is smaller than the distance between the protrusion 26 and the inner wall surface 112a of the slot 112.

As shown in FIG. 4, the support member 10 may include an indicator 30 for adjusting the phase of the stator core 110 with respect to the support member 10, in addition to the disc-shaped base portion 12, the cylindrical tubular outer support portion 14, and the columnar inner support portion 16.

The indicator 30 is a plurality of cutouts formed in the positioning portion 28 at equal intervals in a direction along the circumferential direction of the inner support portion 16, but is not limited thereto. For example, the indicator 30 may be a mark provided on the surface of the positioning portion 28. Alternatively, the indicator 30 may be a mark provided on the one end surface of the outer support portion 14.

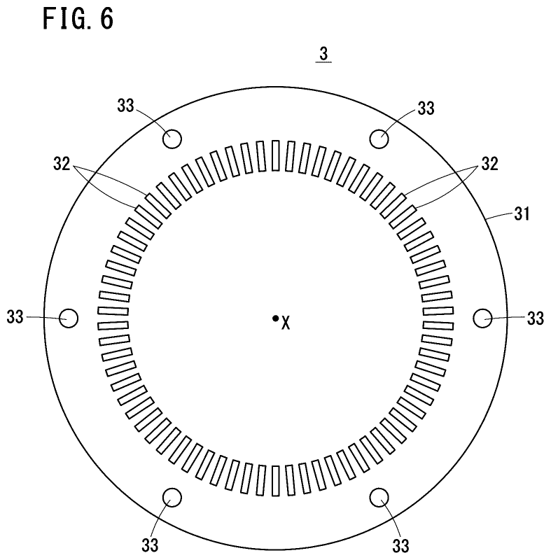

As shown in FIGS. 3 and 6, the pressing jig 3 is a jig for pushing out the coil 120 from the slots 112 of the stator core 110. The pressing jig 3 includes a disc-shaped tool base 31 and a plurality of pushing members 32.

The tool base 31 and the plurality of pushing members 32 are formed of, for example, metal such as stainless steel. The tool base 31 and the plurality of pushing members 32 may be formed integrally or separately. When the tool base 31 and the plurality of pushing members 32 are formed separately, the tool base 31 and the plurality of pushing members 32 are joined by welding or the like. The tool base 31 and the plurality of pushing members 32 are disposed at predetermined positions of the coil separation device 1.

The tool base 31 is attached to a pressing device which is linearly operated by a cylinder or the like (not shown). The tool base 31 is configured to be linearly movable along the central axis X of the stator 100. A plurality of support post through holes 33 are formed in the tool base 31 at equal intervals along the circumferential direction. The plurality of support post through holes 33 are holes through which the guiding support posts 5 are inserted when the coil 120 is removed from the stator 100. The plurality of support post through holes 33 are provided correspondingly to the positions of the plurality of through holes 113 formed in the stator core 110.

The plurality of pushing members 32 are fixed to the tool base 31 so as to extend from the tool base 31 in the same direction. The plurality of pushing members 32 are radially arranged at equal intervals so as to surround the central axis X of the tool base 31. The pushing members 32 equally extend. The length of the pushing members 32 in the direction along the central axis X is equal to or greater than the length of the slots 112 in the direction along the central axis X. The length of the pushing members 32 in the radial direction of the tool base 31 is smaller than the length of the slots 112 in the radial direction of the stator core 110. The normal direction of the distal end surfaces of the pushing members 32 coincide with the extending direction (longitudinal direction) of the pushing members 32. The distal end surfaces of the pushing members 32 are flat.

The number and arrangement of the pushing members 32 correspond to the number and arrangement of the slots 112 of the stator core 110, respectively. The pushing member 32 has the same cross-sectional shape wherever it is cut in a direction perpendicular to the direction of the central axis X of the tool base 31. The pushing members 32 are slightly smaller in cross section than the slots 112 open to the first end surface F10 and the second end surface F20 of the stator core 110. Therefore, the pushing members 32 can be inserted into the corresponding slots 112, respectively.

As shown in FIG. 3, in the coil separation device 1, the arrangement jig 2 and the pressing jig 3 are positioned coaxially along the central axis X at least during the coil separation operation. At least one of the arrangement jig 2 and the pressing jig 3 is provided to be rotatable around the central axis X by the operation of a rotation mechanism (not shown). Such a rotation mechanism is provided in the coil separation device 1.

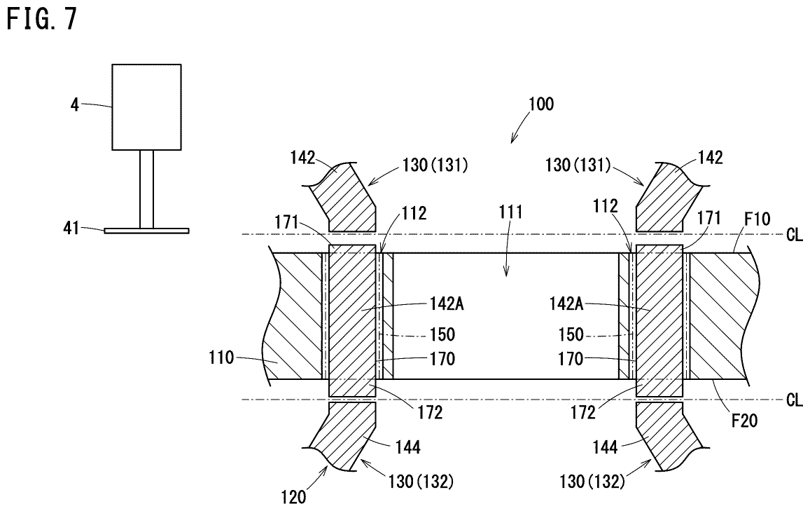

Next, a coil separation method using the coil separation device 1 will be described with reference to FIGS. 7 to 11.

First, as shown in FIG. 7, the two coil end portions 130 (the first coil end portion 131 and the second coil end portion 132) of the stator core 110 are cut by using the cutting device 4 having a rotary blade 41. The rotary blade 41 cuts the coil end portions 130 along cut lines CL parallel to the end surfaces (the first end surface F10 and the second end surface F20) of the stator core 110 from the outer peripheral side or the inner peripheral side of the coil end portions 130. Thus, the coil end portions 130 are separated.

The cut lines CL are set at positions close to the end surfaces (the first end surface F10 and the second end surface F20) of the stator core 110. Specifically, the cut lines CL are set at roots 171 of the first coil end portion 131 and roots 172 of the second coil end portion 132. After the two coil end portions 130 are cut, substantially straight portions of the coil 120 remain in the stator 100.

Next, as shown in FIG. 8, the stator 100 from which both the first coil end portion 131 and the second coil end portion 132 have been cut is conveyed to a predetermined position of the coil separation device 1 by the operation of a conveying apparatus such as a robot hand (not shown). Specifically, the stator 100 is disposed between the arrangement jig 2 and the pressing jig 3 in a state where the first end surface F10 of the stator core 110 faces the arrangement jig 2 and the second end surface F20 of the stator core 110 faces the pressing jig 3.

When arranging the stator 100, the guiding support posts 5 are inserted into the plurality of support post insertion holes 20 of the support member 10, respectively. The guiding support posts 5 inserted into the support post insertion holes 20 protrude in the normal direction of the support surface F30 of the support member 10. The guiding support posts 5 may be provided in the support post insertion holes 20 in advance.

The stator 100 is positioned with respect to the support member 10 by inserting the guiding support posts 5 into the plurality of through holes 113, respectively. While being positioned, the stator 100 is moved toward the support member 10 along the guiding support posts 5 by operation of a conveying device (not shown). Thereafter, the first end surface F10 of the stator core 110 abuts against the support surface F30 of the support member 10.

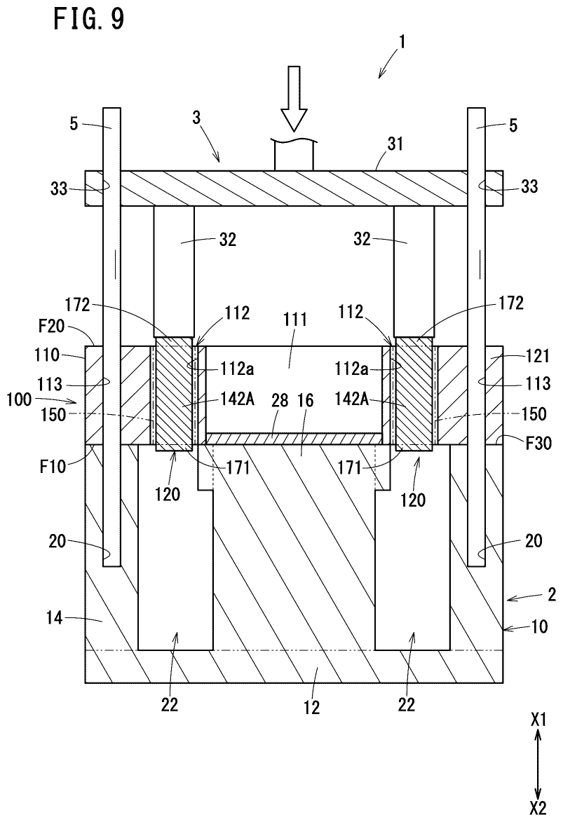

As shown in FIG. 9, in a state where the first end surface F10 of the stator core 110 is in contact with the support surface F30 of the support member 10, the outer support portion 14 of the support member 10 supports the core body 121. As shown in FIG. 5, the plurality of protrusions 26 formed on the inner support portion 16 of the support member 10 support the teeth 122, respectively. The support member 10 is provided with the indicator 30 for adjusting the phase of the stator core 110 with respect to the support member 10. Thus, it is possible to check whether or not the protrusions 26 and the teeth 122 are aligned.

In a state where the first end surface F10 of the stator core 110 is in contact with the support surface F30 of the support member 10, the circumferential surface F28 of the positioning portion 28 disposed on the support surface F30 of the inner support portion 16 is in contact with the tip end surfaces F122 of the teeth 122. Further, the slots 112 are open in the radial direction of the stator core 110 at positions within the recesses 24 between the protrusions 26 and away from the circumferential surface F28 of the positioning portion 28.

After the first end surface F10 of the stator core 110 is brought into contact with the support surface F30 of the support member 10, at least one of the arrangement jig 2 and the pressing jig 3 is rotated around the central axis X by the operation of the rotation mechanism (not shown). Thus, the coil separation device 1 performs phase matching between the plurality of pushing members 32 of the pressing jig 3 and the plurality of slots 112 formed in the stator core 110. Thus, the plurality of slots 112 and the plurality of pushing members 32 are made in alignment with each other along the direction of the central axis X of the stator 100.

After the phase alignment, the pressing jig 3 is moved in the X2 direction toward the stator 100 by the operation of the pressing device (not shown). In response to this movement, each of the plurality of guiding support posts 5 penetrating the stator 100 is inserted into the support post through holes 33, whereby the pressing jig 3 is positioned with respect to the stator 100.

When the pressing jig 3 further moves in the X2 direction toward the stator 100, as shown in FIG. 9, the distal ends of the pushing members 32 abut respectively against the cut ends of the coil placed in the slots 112 and slightly protruding from the second end surface F20 of the stator core 110. The cut ends belong to the roots 172 of the second coil end portion 132 (FIG. 7).

When the pressing jig 3 further moves in the X2 direction, as shown in FIG. 5, the pushing members 32 simultaneously push the first portions 142A of the coil 120 in the corresponding slots 112 in the X2 direction. As a result, the coil 120 gradually moves with respect to the stator core 110 toward the support member 10. Since the support member 10 supports the core body 121 and the teeth 122 on the first end surface F10 of the stator core 110, the pressing jig 3 can stably push the coil 120 of the stator 100.

As shown in FIG. 7, the length of the straight portions 170 included in the roots 171 of the first coil end portion 131 is shorter than the length of the straight portions 170 included in the roots 172 of the second coil end portion 132. Therefore, when the roots 171 of the first coil end portion 131 is cut, there is a possibility that the rotary blade 41 may cut not the straight portions of the roots 171 but the bent portions of the first coil end portion 131 (see FIG. 7). When it happens, even after the first coil end portion 131 is cut, the remaining portions of the roots 171 continuous from the first portions 142A of the coil 120 overlap the stator core 110 in the direction along the central axis X of the stator core 110. In this case, when the coil 120 is pushed toward the support member 10, the remaining portions of the roots 171 are caught by the stator core 110, leading to an increase in the load on the pressing jig 3.

In the present embodiment, the cut ends of the roots 172 of the second coil end portion 132 are pushed, instead of the roots 171 of the first coil end portion 131. This can prevent the coil 120 from being caught by the stator core 110 when the coil is moved toward the support member 10. As a result, it is possible to suppress an excessive increase in the load on the pressing jig 3.

In response to the movement of the coil 120 toward the support member 10, the insulation papers 150 covering the first portions 142A of the coil 120 positioned in the slots 112 also move toward the support member 10. This is because the frictional resistance between the insulation papers 150 and the first portions 142A of the coil 120 is larger than the frictional resistance between the insulation papers 150 and the stator core 110. As shown in FIG. 5, the protrusions 26 of the inner support portion 16 of the support member 10 support the central portions of the tip ends of the teeth 122. Both the protrusions 26 and the recesses 24 are displaced from the inner wall surfaces 112a of the slots 112. Therefore, even when the insulating papers 150 covering the coil 120 move toward the support member 10, contact between the insulating papers 150 and the inner support portion 16 can be avoided. As a result, it is possible to suppress an increase in the load of the pressing jig 3 due to the insulating papers 150 contacting the support member 10.

A positioning portion 28 for positioning the stator core 110 in the radial direction is disposed on the one end surface of the inner support portion 16. The positioning portion 28 has a circumferential surface F28 facing the tip end surfaces F122 of the teeth 122 supported by the support surface F30 of the support member 10. This can suppress the stator core 110 from being out of alignment with the support member 10. Therefore, the coil 120 and the insulation papers 150 covering the first portions 142A of the coil 120 can be guided in the direction along the central axis X of the stator core 110.

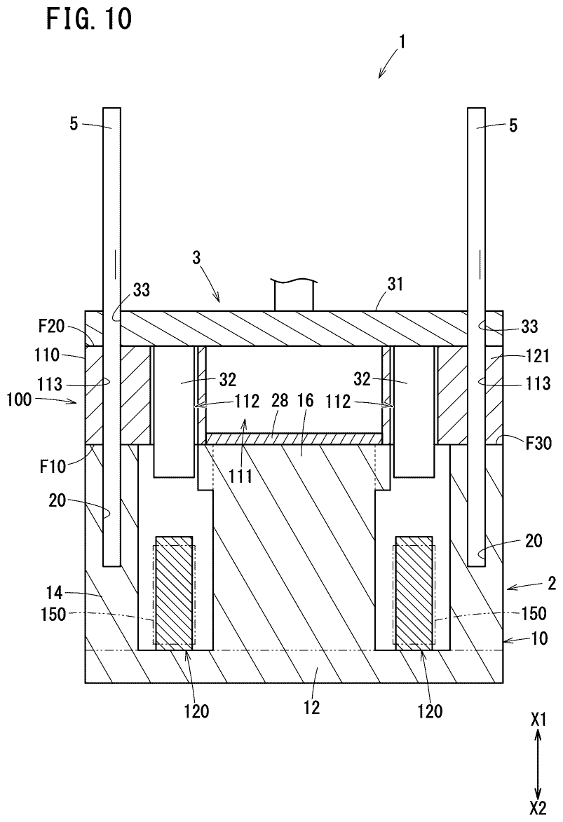

The length of the pushing members 32 in the direction along the central axis X is equal to or greater than the length of the slots 112 in the direction along the central axis X. Therefore, as shown in FIG. 10, when the tool base 31 of the pressing jig 3 moves until it abuts against the second end surface F20 of the stator core 110, the distal ends of the pushing members 32 protrude from the first end surface F10 of the stator core 110. Therefore, the coil 120 is pushed out from the slots 112 of the stator core 110 in one stroke.

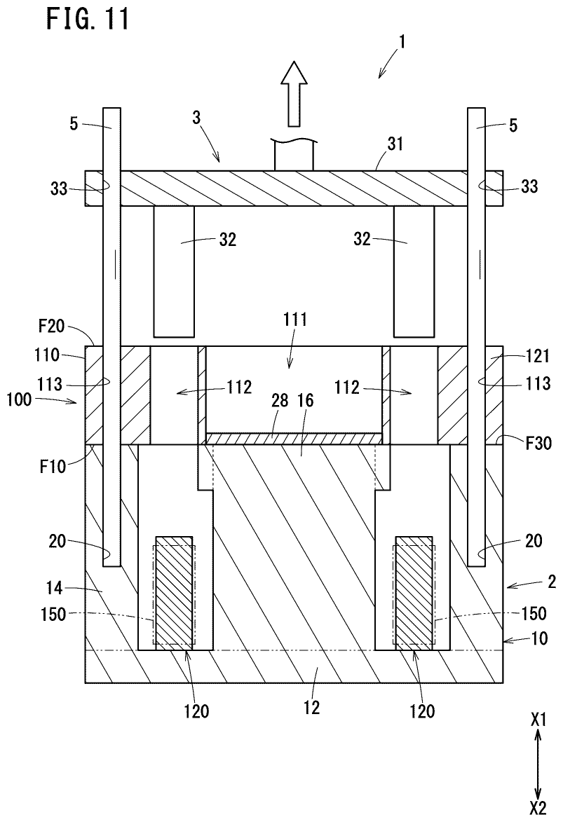

Thereafter, as shown in FIG. 11, the pressing jig 3 moves in the X1 direction so as to be away from the arrangement jig 2. Thus, the pressing jig 3 is returned to its initial position, and the separating operation is finished.

The coil separation method and the coil separation device 1 described above separate the coil 120 from the stator core 110 by pushing the cut ends of the coil 120 with the pushing member 32 in a state where the teeth 122 are supported by the support member 10. Thus, it is not necessary to forcibly deform the outer surface of the coil end portions 130 by pressing. Therefore, the amount of impurities contained in the coil 120 separated from the stator core 110 does not increase, and the range in which the coil 120 can be recycled is not limited. Moreover, the coil 120 can be smoothly moved inside the slots 112 along the central axis X of the stator core 110. As a result, the coil 120 can be easily removed from the stator 100 without forcibly deforming the coil 120.

The above-described embodiment may be modified as follows.

The guiding support posts 5 may be inserted through the arrangement jig 2 and the stator 100, and may not be inserted through the pressing jig 3. Alternatively, the guiding support posts 5 may not be provided.

The protrusions 26 of the support member 10 may be extended along the radial direction of the stator core 110 and be connected to the outer support portion 14.

Alternatively, although not shown, the support member 10 may include a first biasing support portion and a second biasing support portion, instead of the base portion 12, the outer support portion 14, and the inner support portion 16. The first biasing support portion biases the tip end surfaces F122 of one or more teeth 122 among the plurality of teeth 122 toward the outer side of the stator core 110. The second biasing support portion biases toward the outer side of the stator core 110 the tip end surfaces F122 of the teeth 122, which are positioned on the opposite side to the teeth 122 biased by the first biasing support portion.

Alternatively, although not shown, the support member 10 may include radial support portions, instead of the base portion 12, outer support portion 14, and inner support portion 16. The radial support portions extend radially in correspondence with the plurality of teeth 122 of the stator core 110, and support the teeth 122 on the first end surface F10 of the stator core 110.

A plurality of types of pressing jigs 3 may be prepared, each of which has the pushing members 32 of a size and a number corresponding to the size of the stator 100, the number of the slots 112 of the stator core 110, and the like. In this case, the coil separation device 1 may be configured to select and use an optimal pressing jig 3 according to the type of the stator 100 to be separated.

The number of the pushing members 32 provided in the pressing jig 3 is not limited to be equal to the number of slots 112 of the stator core 110. The pushing members 32 may be provided in the tool base 31 in a number smaller than the number of the slots 112 as long as the pushing members 32 push the coil 120 in arbitrary ones of the plurality of slots 112 formed in the stator core 110. The number of the pushing members 32 may be one. In this case, the coil separation device 1 repeats the pressing operation and the phase matching operation alternately. In this manner, all the coil 120 on each of the plurality of teeth 122 can be separated from the stator core 110.

The plurality of pushing members 32 of the pressing jig 3 are not limited to those having the same length in the extending direction. The pressing jig 3 may include pushing members 32 having different lengths in the extending direction so as to be able to press the plurality of first portions 142A arranged in the slots 112 one after another.

The distal end surfaces of the pushing members 32 of the pressing jig 3 are not limited to flat surfaces perpendicular to the extending direction. The distal end surfaces of the pushing members 32 may be inclined in the radial direction of the stator core 110 so as to press the plurality of first portions 142A in the slots 112 one after another in the radial direction.

The coil 120 may be wound around the teeth 122 or bobbins. The coil 120 is not limited to flat wires.

The following supplementary notes are further disclosed in relation to the above embodiment.

### Supplementary Note 1

The coil separation method is provided to remove the coil (120) from the stator (100) including: the stator core (110) having an inner circumferential surface in which the plurality of slots (112) are formed; and the coil placed in the plurality of slots, and the coil separation method includes: cutting, from the coil, coil end portions (130) protruding from any of end surfaces of the stator core; and separating the coil from the stator core by pushing the cut ends of the coil with the pushing member (32) in the state where teeth (122) of the stator core that are positioned between the slots are supported by the support member (10).

### Supplementary Note 2

The coil separation method according to Supplementary Note 1, wherein the coil includes the plurality of segment conductors (140) each having the pair of legs (142) and the turn portion (144) connecting the pair of legs, the legs including the first portions (142A) inserted into the slots, the second portions (142B) protruding from the first end surface (F10) which is one of end surfaces of the stator core, and the third portions (142C) protruding from the second end surface (F20) which is another of the end surfaces of the stator core, the coil end portion includes: the first coil end portion (131) protruding from the first end surface and formed of the second portions of the pair of legs; and the second coil end portion (132) protruding from the second end surface and formed of the turn portion and the third portions of the pair of the pair of legs, wherein in the cutting, both the first coil end portion and the second coil end portion may be cut, and in the separating, the cut ends of the second coil end portion may be pushed by the pushing member in a state where the teeth are supported by the support member on the first end surface.

### Supplementary Note 3

A coil separation device (1) is configured to remove a coil from a stator including a stator core having an inner circumferential surface in which a plurality of slots are formed and the coil placed in the plurality of slots, and the coil separation device includes: a support member configured to support teeth of the stator core that are positioned between the slots of the stator core, from which a coil end portion protruding from any of end surfaces of the stator core has been cut; and a pushing member configured to push cut ends of the coil to separate the coil from the stator core, in a state where the teeth are supported.

### Supplementary Note 4

The coil separation method according to Supplementary Note 3, wherein the coil includes the plurality of segment conductors each having the pair of legs and the turn portion connecting the pair of legs, the legs including the first portions inserted into the slots, the second portions protruding from the first end surface which is one of end surfaces of the stator core, and the third portions protruding from the second end surface which is another of the end surfaces of the stator core, the coil end portion includes: the first coil end portion protruding from the first end surface and formed of the second portions of the pair of legs; and the second coil end portion protruding from the second end surface and formed of the turn portion and the third portions of the pair of the pair of legs, wherein the support member may support on the first end surface the teeth of the stator, from which both the first coil end portion and the second coil end portion have been cut, and the pushing member may push the cut ends of the second coil end portion.

### Supplementary Note 5

In the coil separation device according to Supplementary Note 3 or 4, the support member may support the teeth at one of the end surfaces and may support an outer circumferential portion of the stator core at the one of the end surfaces.

### Supplementary Note 6

In the coil separation device according to Supplementary Note 3 or 4, the support member may include the cylindrical tubular outer support portion (14) and the columnar inner support portion (16) positioned inwardly of the outer support portion and spaced apart from the outer support portion, the inner support portion has the outer peripheral surface with the plurality of recesses (24) formed at intervals in the circumferential direction of the inner support portion, the plurality of recesses may extend from one end surface of the inner support portion in the direction along the axis of the inner support portion, the teeth may abut on the protrusions (26) defined by the recesses, and the outer circumferential portion of the stator core may abut on the outer support portion.

### Supplementary Note 7

In the coil separation device according to Supplementary Note 6, the positioning portion (28) may be disposed on the one end surface of the inner support portion and configured to position the stator core in the radial direction.

### Supplementary Note 8

In the coil separation device according to Supplementary Note 7, the positioning portion may have the circumferential surface (F28) that faces the tip end surfaces (F122) of the teeth in the state where the teeth are supported.

### Supplementary Note 9

In the coil separation device according to Supplementary Note 6, the support member may be provided with the indicator (30) for adjusting the phase of the stator core with respect to the support member.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the contents described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

1. A coil separation method of separating a coil from a stator including: a stator core having an inner circumferential surface in which a plurality of slots are formed; and the coil placed in the plurality of slots, the coil separation method comprising:
cutting, from the coil, a coil end portion protruding from any of end surfaces of the stator core; and
separating the coil from the stator core by pushing cut ends of the coil with a pushing member in a state where teeth of the stator core that are positioned between the slots are supported by a support member.

2. The coil separation method according to claim 1, wherein
the coil includes a plurality of segment conductors each having a pair of legs and a turn portion connecting the pair of legs,
the legs including first portions inserted into the slots, second portions protruding from a first end surface which is one of end surfaces of the stator core, and third portions protruding from a second end surface which is another of the end surfaces of the stator core,
the coil end portion includes a first coil end portion protruding from the first end surface and formed of the second portions of the pair of legs and a second coil end portion protruding from the second end surface and formed of the turn portion and the third portions of the pair of the pair of legs,
wherein in the cutting, both the first coil end portion and the second coil end portion are cut, and
in the separating, the cut ends of the second coil end portion are pushed by the pushing member in a state where the teeth are supported by the support member on the first end surface.

3. A coil separation device configured to remove a coil from a stator including: a stator core having an inner circumferential surface in which a plurality of slots are formed; and the coil placed in the plurality of slots, the coil separation device comprising:
a support member configured to support teeth of the stator core that are positioned between the slots of the stator, from which a coil end portion protruded from any of end surfaces of the stator core has been cut; and
a pushing member configured to push cut ends of the coil to separate the coil from the stator core, in a state where the teeth are supported.

4. The coil separation device according to claim 3, wherein the coil includes a plurality of segment conductors each having a pair of legs and a turn portion connecting the pair of legs,
the legs including first portions inserted into the slots, second portions protruding from a first end surface which is one of the end surfaces of the stator core, and third portions protruding from a second end surface which is another of the end surfaces of the stator core,
the coil end portion includes: a first coil end portion protruding from the first end surface and formed of the second portions of the pair of legs; and a second coil end portion protruding from the second end surface and formed of the turn portion and the third portions of the pair of the pair of legs,
wherein the support member is configured to support on the first end surface the teeth of the stator, from which both the first coil end portion and the second coil end portion have been cut, and
the pushing member is configured to push the cut ends of the second coil end portion.

5. The coil separation device according to claim 3, wherein
the support member is configured to support, at one of the end surfaces, the teeth and an outer circumferential portion of the stator core.

6. The coil separation device according to claim 3, wherein
the support member includes:
a cylindrical tubular outer support portion;
a columnar inner support portion positioned inwardly of the outer support portion and spaced apart from the outer support portion, wherein
the inner support portion has an outer peripheral surface with a plurality of recesses formed at intervals in a circumferential direction of the inner support portion,
the plurality of recesses extend from one end surface of the inner support portion in a direction along an axis of the inner support portion,
the teeth abut on protrusions defined by the recesses, and
an outer circumferential portion of the stator core abuts on the outer support portion.

7. The coil separation device according to claim 6, wherein
a positioning portion is disposed on the one end surface of the inner support portion and configured to position the stator core in a radial direction.

8. The coil separation device according to claim 7, wherein
the positioning portion has a circumferential surface that faces tip end surfaces of the teeth in a state where the teeth are supported.

9. The coil separation device according to claim 6, wherein
the support member is provided with an indicator used in adjusting a phase of the stator core with respect to the support member.
